(19) United States
(12) Patent Application Publication
(10) Pub. No.: US 2015/0112828 A1
(43) Pub. Date: Apr. 23, 2015

(54) System and Method for Facilitating Service Transactions Online

(71) Applicant: Mohammad Qasem, Las Vegas, NV (US)

(72) Inventor: Mohammad Qasem, Las Vegas, NV (US)

(21) Appl. No.: 14/518,819

(22) Filed: Oct. 20, 2014

Related U.S. Application Data
(60) Provisional application No. 61/892,991, filed on Oct. 18, 2013.

(51) Int. Cl. G06Q 30/08

(52) U.S. Cl. CPC G06Q 30/08
USPC 705/26.3

(57) ABSTRACT

Systems and methods for facilitating a service transaction bidding process online which involves filtering all quotes received and displaying only a dynamic subset of all quotes received for a requested service, wherein inclusion in the subset is based on the financial appeal of at least one common feature of the quotes received and providers submitting quotes that are filtered out and not included in the dynamic subset are notified and queried to submit more competitive quotes.

### CROSS REFERENCE TO RELATED APPLICATIONS

This application claims priority to U.S. Provisional Application Ser. No. 61/892,991, filed Oct. 18, 2013, the disclosure of which is hereby incorporated by reference in its entirety.

### BACKGROUND OF THE INVENTION

1. Field of the Invention

The invention generally relates to systems and methods for facilitating service transactions through an online bidding system.

2. Background of the Related Art

Online auctions have become a popular activity for users interested in purchasing goods online. Many online auctions allow a person to bid on an item in an attempt to obtain a winning bid and an associated opportunity to purchase the auction item at the winning bid price. Known online auction websites allow several users to compete with other online auction participants by submitting bids on a particular item until a predefined period of time has elapsed, and the highest bidder is determined. Auctions typically involve goods, therefore, online auctions that provide the opportunity for service professionals to bid on service requests from customers are needed. Often, the first bid a bidder makes is not the winning bid, and bidders must watch the auction and change their bids when a more competitive bid is placed by a third party.

For at least the foregoing reasons, there is a compelling need in the art for systems and methods that would facilitate service transactions and a competitive bidding system amongst service providers.

### SUMMARY OF THE INVENTION

Some embodiments of the invention provide systems and methods for addressing the needs mentioned above, among other things.

Some embodiments of the invention are directed to a method of facilitating a service transaction bidding process online comprising the steps of: receiving a service request from a user through a data communication device to actuate a service transaction bidding event, the service request including a selection of a service from a preset list of services available for request, wherein each preset service of the preset list of services available for request includes a preset financial impact term, the preset financial impact factor being directly associated with the cost to the user for the preset services available for request; notifying service providers of the service request through the data communication device; receiving quotes responsive to the service request from the service providers through the data communication device, wherein each quote received includes an inputted numerical value for the financial impact term; a data processor facilitating the step of forming a dynamic subset from the quotes received, wherein the dynamic subset includes a limited amount of the quotes received determined to be associated with the least cost to the user for the selected service requested based on a comparison of the inputted numerical values included in the quotes received; displaying the dynamic subset of the quotes received to the user through the data communication device, wherein the remaining quotes received not included in the dynamic subset are not displayed to the user; and notifying the service providers from which the remaining quotes were received through the data communication device that the quotes received were not included in the dynamic subset and query for a new quote from the service providers notified until a service transaction bidding termination event is detected.

In some embodiments, the aforementioned method further comprises the step of storing service provider registration data in a database, wherein the service provider registration data includes contact data and a selection of one or more services from the preset list of services available for request from a plurality of service providers.

In some embodiments, the aforementioned method further comprises the step of the data processor facilitating the step of comparing the service request with the registration data and identifying service providers with matching selected services.

In some embodiments, the aforementioned method further comprises the step of notifying service providers of the service request through the data communication device further comprises providing the inputted numerical values of the quotes received included in the dynamic subset.

In some embodiments, the aforementioned method further comprises the step of notifying service providers of the service request through the data communication device further comprises providing a communication interface with data entry fields for submitting quotes and inputting numerical values for the financial impact term.

In some embodiments of the aforementioned method, the dynamic subset includes no more than three of the quotes received.

In some embodiments, the aforementioned method further comprises the step of notifying the service providers from which the remaining quotes were received that the quotes received were not included in the dynamic subset further comprises notifying of the quotes received that are included in the dynamic subset.

In some embodiments of the aforementioned method the service transaction bidding termination event comprises the expiration of a preset time period.

In some embodiments of the aforementioned method the service transaction bidding termination event comprises receiving a selection of a quote received from the dynamic subset through the data communication device.

In some embodiments, the invention is directed to a service transaction bidding process online comprising the steps of: a) storing service provider registration data in a database, wherein the service provider registration data includes contact data and a selection of one or more services from a preset list of services available for request from a plurality of service providers, wherein each preset service of the preset list of services available for request includes a preset financial impact term, the preset financial impact term being directly associated with the cost to the user for the preset services available for request; b) receiving a service request from a user through a data communication device to actuate a services transaction bidding process event, the service request including a selection of a service from the preset services for request; c) a data processor facilitating the step of comparing the service request with the registration data and identifying service providers with matching selected services; d) notifying the identified service providers of the selected service requested through the data communication device; e) receiving quotes responsive to the service request from the service providers through the data communication device, wherein each quote received includes an inputted numerical value for the financial impact term; f) the data processor facilitating the step of forming a dynamic subset from the quotes received, wherein the dynamic subset includes a limited amount of the quotes received determined to be associated with the least cost to the user for the selected service requested based on a comparison of the inputted numerical values included in the quotes received; g) displaying the dynamic subset of the quotes received to the user through the data communication device, wherein the remaining quotes received not included in the dynamic subset are not displayed to the user; h) notifying the service providers from which the remaining quotes were received that the quotes received were not included in the dynamic subset; and repeating steps e) through h) until a service transaction bidding process termination event is detected.

In some embodiments, the aforementioned method further comprises the step of providing a communication interface with data entry fields for submitting service requests.

In some embodiments, the aforementioned method further comprises the step of notifying service providers of the service request through the data communication device further comprises providing a communication interface with data entry fields for submitting quotes and inputting numerical values for the financial impact term.

In some embodiments, the aforementioned method further comprises the step of notifying the service providers from which the remaining quotes were received that the quotes received were not included in the dynamic subset further comprises notifying of the quotes received that are included in the dynamic subset.

In some embodiments, the service transaction bidding termination event comprises receiving a selection of a quote received from the dynamic subset through the data communication device.

Some embodiments of the invention are also directed to a system for facilitating a service transaction bidding process online comprising: a data communication device configured to: receive a service request from a user to actuate a service transaction bidding event, the service request including a selection of a service from a preset list of services available for request, wherein each preset service of the preset list of services available for request includes a preset financial impact term, the preset financial impact term being directly associated with the cost to the user for the preset services available for request; notify service providers of the service request through the data communication device; receive quotes responsive to the service request from the service providers through the data communication device, wherein each quote received includes an inputted numerical value for the financial impact term; a data processor configured to form a dynamic subset from the quotes received, wherein the dynamic subset includes a limited amount of the quotes received determined to be associated with the least cost to the user for the selected service requested based on a comparison of the inputted numerical values included in the quotes received; and a display device configured to display the dynamic subset of the quotes received to the user through the communication device, wherein the remaining quotes received not included in the dynamic subset are not displayed to the user, wherein the data communication device is configured to notify the service providers from which the remaining quotes were received that the quotes received were not included in the dynamic subset and query for a new quote from the service providers notified until a service transaction bidding termination event is detected.

In some embodiments, the aforementioned system further comprises a database configured to store service provider registration data in a database, wherein the service provider registration data includes contact data and a selection of one or more services from the preset list of services available for request from a plurality of service providers.

In some embodiments, the data processor may be configured to compare the service request with the registration data and identifying service providers with matching selected services and the display device is a user device, such as a home computer or mobile phone.

### BRIEF DESCRIPTION OF THE FIGURES

So that those having ordinary skill in the art to which at least some embodiments of the invention pertains will more readily understand how to make and use systems and methods in accordance therewith, such embodiments thereof will be described in enabling detail herein below with reference to the drawings, wherein:

FIG. 1 is a flow diagram depicting operational steps employed by a system and method formed in accordance with some embodiments of the invention; and

FIG. 2 is a block diagram of representative components of a service transaction bidding system in which certain embodiments such as the embodiment shown in FIG. 1 may be employed.

### DETAILED DESCRIPTION OF THE INVENTION

In some embodiments, the systems and methods of the invention provide a system and method to facilitate competition between service providers to the benefit of the providers in the form of new and increased service opportunities and transactions, and to the benefit of the consumers or users in the form of obtaining service providers at less financial impact or cost for the services.

For example, the systems and methods of the invention may facilitate a consumer request for help with a real estate purchase or sale and the subsequent selection of a real estate professional, commonly referred to as a real estate agent, through a bidding process in which real estate professionals provide attractive terms for the services for the consumer to consider, such as lower commission on a sale of real estate by the consumer or a greater rebate of the commission received as a result of a purchase of real estate by the consumer.

The systems and method of the invention can be implemented with or through software programs, conventional hardware components, such as processing and data storage devices, and communication over a global communication network, such as the Internet. It is expected that one of ordinary skill, notwithstanding possibly significant effort and many design choices motivated by, for example, available time, current technology, and economic considerations, when guided by the concepts and principles disclosed herein will be readily capable of generating such software programs and appropriate hardware for execution thereof with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

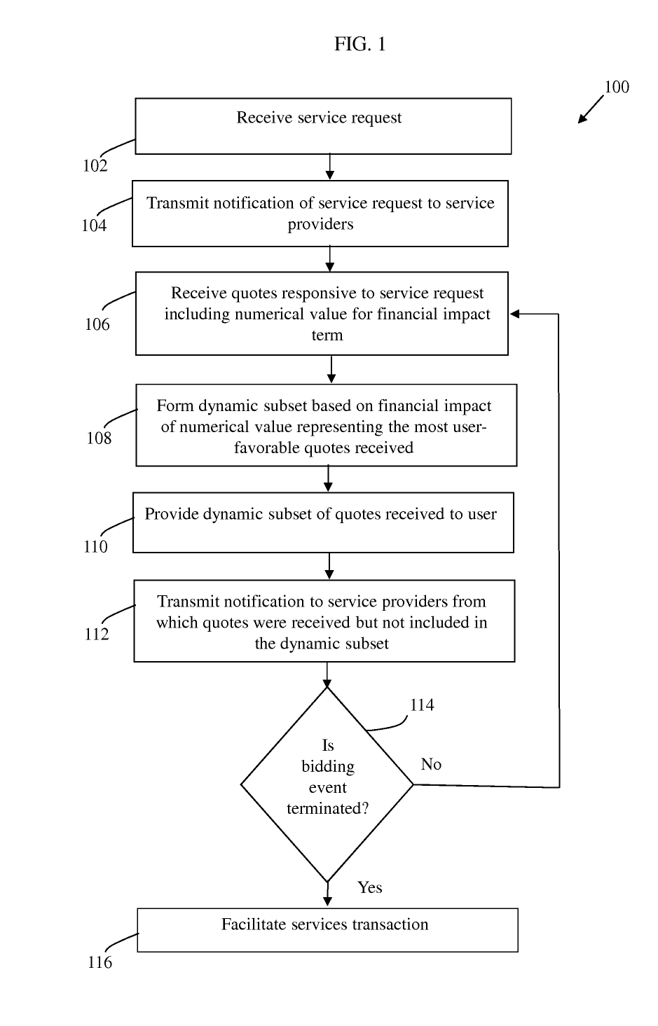

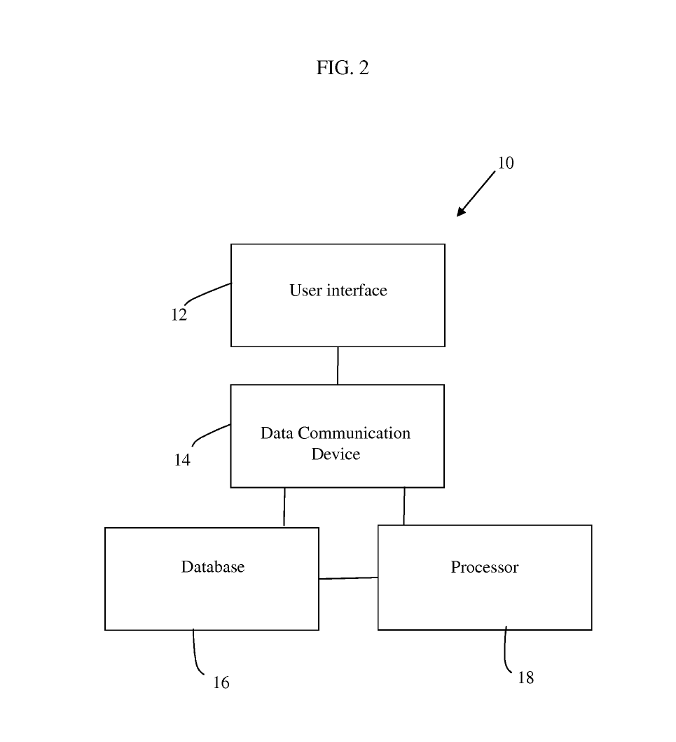

FIG. 1 provides a process flow diagram which illustrates operational steps employed by an exemplary embodiment of the method of the invention referred to as method 100 and for illustrative purposes is discussed in connection with a system 10 as shown in FIG. 2.

As shown by step 102, a service request is received by system 10 from a user through a user interface 12, such as a website on the Internet or a downloadable application for use and display on a computing platform or mobile phone, which is in communication with a data communication device 14. The receipt of a service request actuates a bidding event involving the service request which is intended to lead to a transaction between a service provider and the user for the provision or performance of the services. The service request may include a selection of a service from a preset list of services available for request. The list of available services may be provided by user interface 12. It should be understood that the specific list may differ depending on the location of the user, location at which the service is to be performed and/or the type of service requested, and the availability of service providers.

As shown by step 104, service providers are notified of the service request through a data communication device such as device 14, which may comprise the provision of an email or text. In some embodiments, service providers must first register or sign up with system 10 to be notified and/or permitted to participate in a bidding event. The service provider may be required to provide contact information which would be received through user interface 12 for storage in database 16 and verify certain relevant credentials such as licensure or proof of insurance or provide references. The service provider may also be queried as to which of the preset list of services the service provider is capable of fulfilling and the geographical area in which the service provider generally works so that system 10 may notify the service provider via data communication device 14 upon receipt of a corresponding and appropriate service request.

As shown by step 106, offers or quotes responsive to the service request may be received from the service providers through data communication device 14 and processed by data processor 18. In embodiments where registration data is stored, service providers having selected the same service from the preset list of services as the service request will be determined via data processor 18, with further consideration of any relevant geographical limitations, and notified through data communication device 14.

It is envisioned that a quote provided in step 106 may include various information relevant to the service request, with each quote including an inputted numerical value for a relevant financial impact term. The financial impact term relates to any measure that the consumer can use to compare the expense or relative cost and financial benefit of the service. It should be readily apparent that the financial impact term will differ depending on the service requested. In this embodiment, the financial impact term is preset by system 10 based on the service request. For example, the financial impact term for a service request relating to a home sale can be the percentage commission, whereas the financial impact term for a service request relating to a home purchase may be an amount which the professional is willing to rebate from the commission earned by the professional to the user. The financial impact term for other service requests may be the charge for the service requested or some other feature relative to the service request, such as closing costs or interest rate. System 10 may be provide an electronic form with data fields for the service provider to submit a quote. In some embodiments, the service providers are registered and may receive notification of the service request and be queried in the notification to input a numerical value so that the quote will be automated by system 10.

In step 108, the quotes received are compared via data processor 18 based on the inputted numerical values and filtered to identify and form a dynamic subset of the quotes received. The dynamic subset includes a limited amount of the quotes received, such as the three quotes in which the financial impact term would be most appealing to the consumer, that is, the quotes received which are associated with the least cost to the user for the service requested based on a comparison of the inputted numerical values.

In step 110, the dynamic subset of the quotes provided to the user through data communication device 14, which may involve displaying the specific quotes, the service provider information or just the numerical values inputted for the financial impact term. In this embodiment, any quotes received which are not included in the dynamic subset are not displayed to the user.

In step 112, any service providers having provided quotes that are not included in the dynamic subset will be notified through data communication device 14 that the quotes received were not included in the dynamic subset. In some embodiments, the notification may further include the inputted numerical values for the quotes included in the dynamic subset and/or a query for a new more competitive quote from the service providers notified.

As shown by step 114, the bidding event may continue until a service transaction bidding termination event occurs or is detected, that is, service providers may submit new quotes which will be compared in step in step 106, and if appropriate, included in the dynamic subset in step 108. In some embodiments, a bidding event may be set to continue until the expiration of a time period or until the user selects a quote of the quote received. Once the bidding event is terminated, system 10 may further facilitate by connecting the service provider and user, who may wish to remain anonymous, as shown by step 116.

In some embodiments, a method such as the method 10 described above may further include a feature enabling users to submit additional criteria that can then be used to sort and parse through quotes received and service providers included in the dynamic subset. The criteria may be based on any information submitted with their registration data or associated with the service provider, such as the provider location, experience, professional accomplishments or certifications, testimonials or ratings that may be provided through customer feedback.

In some embodiments, the invention comprises a series of webpages or a mobile application in which allow users to see and share information related to agents and subject properties as described herein.

It should be understood that the exemplary system 10 depicted in FIG. 2 may be in communication with additional components, subsystems, and elements to provide additional functionality and capabilities without departing from the teaching and disclosure provided herein, and the services may be any kind, such as home selling, home buying, mortgage, title inspection, escrow, pool repair or service, pest control, home improvement, insurance, etc.

Exemplary systems constructed in accordance with embodiments of the invention may include data storage devices or databases, control programs, data processors, and communication devices for receiving and transmitting data. Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as the world wide web or a local or wide area network, and a plurality of data transceiving terminals capable of interfacing with the network.

Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, personal digital assistants (PDAs), cell phones or any other devices capable of displaying a graphical user interface.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database.

Those skilled in the art will further appreciate that the particular types of communication network and devices, software and hardware are not vital to the full implementation of the embodiments described herein or other embodiments within the scope and spirit of the invention. Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

It should be further understood that the type of communication network and devices, software and hardware may also vary and the precise software and hardware configuration of the various embodiments of the invention may vary accordingly while still remaining within the scope and spirit of the invention. With the continuous and ongoing improvements in computer and electronic technology, many modifications may be made to the specific nature of hardware and/or software components required. Accordingly, one of skill in the art may select any hardware components that would rapidly and efficiently process the data and provide storage and communication as needed for the successful operation of some embodiments of the invention.

It will be appreciated by those skilled in the art that while the disclosure of the invention has been described herein in connection with particular embodiments and examples, the invention is not necessarily so limited, and that numerous other embodiments, examples, uses, modifications and departures from the embodiments, examples and uses are intended to be encompassed by the spirit and scope of the invention claimed and its equivalents, as would be understood to one of ordinary skill in the art.

What is claimed is:

1. A method of facilitating a service transaction bidding process online comprising the steps of:
a) receiving a service request from a user through a data communication device to actuate a service transaction bidding event, the service request including a selection of a service from a preset list of services available for request, wherein each preset service of the preset list of services available for request includes a preset financial impact term, the preset financial impact factor being directly associated with the cost to the user for the preset services available for request;
b) notifying service providers of the service request through the data communication device;
c) receiving quotes responsive to the service request from the service providers through the data communication device, wherein each quote received includes an inputted numerical value for the financial impact term;
d) a data processor facilitating the step of forming a dynamic subset from the quotes received, wherein the dynamic subset includes a limited amount of the quotes received determined to be associated with the least cost to the user for the selected service requested based on a comparison of the inputted numerical values included in the quotes received;
e) displaying the dynamic subset of the quotes received to the user through the data communication device, wherein the remaining quotes received not included in the dynamic subset are not displayed to the user; and
f) notifying the service providers from which the remaining quotes were received through the data communication device that the quotes received were not included in the dynamic subset and query for a new quote from the service providers notified until a service transaction bidding termination event is detected.

2. The method according to claim 1, further comprising the step of storing service provider registration data in a database, wherein the service provider registration data includes contact data and a selection of one or more services from the preset list of services available for request from a plurality of service providers.

3. The method according to claim 2, further comprising the step of the data processor facilitating the step of comparing the service request with the registration data and identifying service providers with matching selected services.

4. The method according to claim 1, wherein the step of notifying service providers of the service request through the data communication device further comprises providing the inputted numerical values of the quotes received included in the dynamic subset.

5. The method according to claim 1, wherein the step of notifying service providers of the service request through the data communication device further comprises providing a communication interface with data entry fields for submitting quotes and inputting numerical values for the financial impact term.

6. The method according to claim 1, wherein the dynamic subset includes no more than three of the quotes received.

7. The method according to claim 1, wherein the step of notifying the service providers from which the remaining quotes were received that the quotes received were not included in the dynamic subset further comprises notifying of the quotes received that are included in the dynamic subset.

8. The method according to claim 1, wherein the service transaction bidding termination event comprises the expiration of a preset time period.

9. The method according to claim 1, wherein the service transaction bidding termination event comprises receiving a selection of a quote received from the dynamic subset through the data communication device.

10. A method of facilitating a service transaction bidding process online comprising the steps of:
a) storing service provider registration data in a database, wherein the service provider registration data includes contact data and a selection of one or more services from a preset list of services available for request from a plurality of service providers, wherein each preset service of the preset list of services available for request includes a preset financial impact term, the preset financial impact term being directly associated with the cost to the user for the preset services available for request;
b) receiving a service request from a user through a data communication device to actuate a services transaction bidding process event, the service request including a selection of a service from the preset services for request;
c) a data processor facilitating the step of comparing the service request with the registration data and identifying service providers with matching selected services;
d) notifying the identified service providers of the selected service requested through the data communication device;
e) receiving quotes responsive to the service request from the service providers through the data communication device, wherein each quote received includes an inputted numerical value for the financial impact term;
f) the data processor facilitating the step of forming a dynamic subset from the quotes received, wherein the dynamic subset includes a limited amount of the quotes received determined to be associated with the least cost to the user for the selected service requested based on a comparison of the inputted numerical values included in the quotes received;
g) displaying the dynamic subset of the quotes received to the user through the data communication device, wherein the remaining quotes received not included in the dynamic subset are not displayed to the user;
h) notifying the service providers from which the remaining quotes were received that the quotes received were not included in the dynamic subset; and
i) repeating steps e) through h) until a service transaction bidding process termination event is detected.

11. The method according to claim 10, further comprising the step of providing a communication interface with data entry fields for submitting service requests.

12. The method according to claim 10, wherein the step of notifying service providers of the service request through the data communication device further comprises providing a communication interface with data entry fields for submitting quotes and inputting numerical values for the financial impact term.

13. The method according to claim 10, wherein the dynamic subset includes no more than three of the quotes received.

14. The method according to claim 10, wherein the step of notifying the service providers from which the remaining quotes were received that the quotes received were not included in the dynamic subset further comprises notifying of the quotes received that are included in the dynamic subset.

15. The method according to claim 10, wherein the service transaction bidding termination event comprises the expiration of a preset time period.

16. The method according to claim 10, wherein the service transaction bidding termination event comprises receiving a selection of a quote received from the dynamic subset through the data communication device.

17. A system for facilitating a service transaction bidding process online comprising:
a) a communication device configured to:
i. receive a service request from a user to actuate a service transaction bidding event, the service request including a selection of a service from a preset list of services available for request, wherein each preset service of the preset list of services available for request includes a preset financial impact term, the preset financial impact term being directly associated with the cost to the user for the preset services available for request;
ii. notify service providers of the service request through the data communication device;
iii. receive quotes responsive to the service request from the service providers through the data communication device, wherein each quote received includes an inputted numerical value for the financial impact term;
b) a data processor configured to form a dynamic subset from the quotes received, wherein the dynamic subset includes a limited amount of the quotes received determined to be associated with the least cost to the user for the selected service requested based on a comparison of the inputted numerical values included in the quotes received;
c) a display device configured to display the dynamic subset of the quotes received to the user through the communication device, wherein the remaining quotes received not included in the dynamic subset are not displayed to the user,
wherein the data communication device is configured to notify the service providers from which the remaining quotes were received that the quotes received were not included in the dynamic subset and query for a new quote from the service providers notified until a service transaction bidding termination event is detected.

18. The system according to claim 17, wherein further comprising a database configured to store service provider registration data in a database, wherein the service provider registration data includes contact data and a selection of one or more services from the preset list of services available for request from a plurality of service providers.

19. The system according to claim 18, wherein the data processor is configured to compare the service request with the registration data and identifying service providers with matching selected services.

20. The system according to claim 17, wherein the display device is a user device.
